(19) United States
(12) Patent Application Publication
(10) Pub. No.: US 2022/0270125 A1
(43) Pub. Date: Aug. 25, 2022

(54) REFERRAL REVENUE SYSTEM

(71) Applicant: i-Refer Global Pty, Ltd., Mudgeeraba (AU)

(72) Inventors: Aleksandar ROMANOV, Mudgeeraba (AU); Nicholas QUINN, Mudgeeraba (AU)

(21) Appl. No.: 17/666,351

(22) Filed: Feb. 7, 2022

(30) Foreign Application Priority Data
Feb. 7, 2021 (AU) 2021100756

(51) Int. Cl. G06Q 30/02

(52) U.S. Cl. CPC G06Q 30/0214; G06Q 30/0215; G06Q 30/0227

(57) ABSTRACT

The present invention discloses a system (100) and method for referral rewards to provide immediate returns on marketing investment. The system (100) comprises at least one referrer device (102), at least one consumer device (104), at least one merchant device (106), a server (108) and a database (110). The server (108) comprises a referrer reward platform (216) to process a referrer reward application (208), the merchant device (106) comprises a merchant referral application (224), and the referrer device (102) comprises a referrer reward application (208) to accomplish referral rewards. The system (100) enables the referrers (114) and merchants (118) to accomplish marketing campaigns by using the referral rewards platform (216).

### CROSS-REFERENCE TO RELATED APPLICATIONS

This application claims priority to under 35 U.S.C. § 119(a) to Australian Application 2021100756, filed Feb. 7, 2021, the entire contents of which are incorporated by reference.

### FIELD OF INVENTION

The field of invention generally relates to referral programs for merchant businesses. More specifically, it relates to a system and method for referral rewards for engaging referrers and merchants on a single platform in order to obtain immediate returns on marketing investment.

### BACKGROUND

In general, marketing companies charge significant funds to undertake marketing campaigns. The funds are required for labour intensive work to setup the marketing campaigns and the commercial leverage required to get the client to the front of the line for the best outcome.

There exist talent acquisition and influencer agencies that are specialized in talent acquisitions for specific or ongoing marketing campaigns of merchants. Marketing companies typically charge a service fee to the merchants for talent acquisition, and the merchant will then be responsible for the ongoing cost of the marketing activities for the duration of the marketing campaign. The capital expenditure that must be outlaid for the engagement of talent, brand ambassadors or influencers does not guarantee a fixed rate of return for the investment in marketing resources.

Existing supply chain and supplier programs are based upon traditional credit account structures in which the conversion from point of sale to settlement of accounts generally falls outside of credit terms agreed between entities. The traditional programs do not allow for the settlement of a realized sale at the point of transaction, therefore inadvertently transforming service providing businesses into credit lending agents, of sorts. Such methods prove volatile to the financial health and cash flow requirements of businesses, in particular small to medium-sized entities. Existing systems, provide referral of products and services of the vendors and service providers, but suffer from the absence of metric and tangible data for referrals. Hence, there are no accurate systems to assess the success of a marketing campaign and the marketing expenditure allocated. Additionally, there are very few marketing Pay-Per-Sale services in the market space, of which no existing services are able to address the accuracy and efficacy of marketing campaigns, thus resulting in wasted marketing expenditure and no guaranteed sales conversions.

Thus, in light of the above discussion, it is implied that there is a need for a system and method for referral rewards, which facilitates immediate settlement of accounts and commissions at point of sale and does not suffer from the problems discussed above.

### OBJECT OF INVENTION

The principal object of this invention is to provide a system and method for facilitating interaction between referrers and merchants on a single platform in order to accomplish/execute referral programs for products or services in return for a financial reward.

The other object of this invention is to provide a system and method for referral rewards to provide immediate returns on marketing investments, based upon the immediate distribution of funds in the total amount settled at the point of sale.

The other object of the invention is to provide an AI-based system that automatically distributes both rewards and funds with respect to a referral transaction.

The other object of the invention is to provide a system that enables tracking of referrals, successful sales and overall success of every campaign by merchants in real-time in order to receive correctly acquired commissions.

A further object of the invention is to provide a system for suppliers to track and settle outstanding accounts at the point of sale by the merchants.

Another object of the invention is to provide a system that facilitates and integrates an e-commerce and in-store platform.

Another object of the invention is to provide a system that facilitates the merchants with most effective referrers.

### BRIEF DESCRIPTION OF FIGURES

This invention is illustrated in the accompanying drawings, throughout which, like reference letters indicate corresponding parts in the various figures.

The embodiments herein will be better understood from the following description with reference to the drawings, in which:

FIG. 1 depicts a block diagram of a system for referral rewards, in accordance with an embodiment;

FIG. 2 illustrates components of the system for referral rewards, in accordance with an embodiment;

FIG. 3 illustrates a block diagram of components of a referral reward application, in accordance with an embodiment;

FIG. 4 illustrates a referral reward method to carry out the referral reward program, in accordance with an embodiment;

FIG. 5 illustrates a method of using the referral reward platform by the merchant devices, in accordance with an embodiment;

FIG. 6 illustrates a method of using the referral reward platform by the referrer devices, in accordance with an embodiment.

### STATEMENT OF INVENTION

The present invention discloses a system and method for performing referral rewards for facilitating immediate returns on investments.

According to an aspect of the invention, a system for referral rewards is disclosed which comprises at least one referrer device, at least one merchant device and a server. The referrer device is configured with a referrer reward application and the merchant device is configured with a merchant referral application. The server is configured with a referral reward platform that communicates and processes data related to the referrer reward application and the merchant referral application by implementing artificial intelligence-based algorithms.

The referral reward platform comprises a merchant module, a code generator, a referrer module, a reward allocator, a funds disburser, a data point generator and an entity verification module.

The merchant module is configured to generate at least one merchant identifier to the merchant device. The merchant device may enter at least one referral program with relevant percentage of rewards. The code generator is configured to generate at least one referral code to the referral program entered by the merchant device. The referrer module is configured to generate at least one referrer identifier to the referrer device. The referrer device may select the referral program and share the referral code corresponding to the selected referral program to the consumer device.

The reward allocator is configured to allocate the relevant percentage of rewards to the referrer device corresponding to the selected referral program when the consumer device utilizes the referral code at point of sale. The funds disburser is configured to distribute funds generated at the point of sale for the referral program among the merchant device, the referrer device and at least one referrer company.

The data point generator is configured to generate and allocate at least one data point to the referrer device for accomplishing the referral program. The data point generator facilitates connecting the merchant device with the best/most effective referrer based on the allocated data points. An entity verification module is configured to verify identities of one or more of the referrer, referrer device, merchant, merchant device and their business entities at the point of registration by communicating with government facilitated systems.

### DETAILED DESCRIPTION

The embodiments herein and the various features and advantageous details thereof are explained more fully with reference to the non-limiting embodiments that are illustrated in the accompanying drawings and/or detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The present invention discloses a system and method for performing referral rewards of products and services. The proposed system facilitates interaction between referrers and merchants on a single platform. The system works with merchants to reward referrers for successful referrals in such a way to both stimulate businesses and provide financial reward for members of the broader community. The system further facilitates tracking referrals and purchases at a point of sale conducted by the merchants.

FIG. 1 depicts a block diagram of a system 100 for referral rewards.

In an embodiment, the system 100 comprises at least one referrer device 102 which is interacted by at least one referrer 114, at least one consumer device 104 which is interacted by at least one consumer 116 and at least one merchant device 106 which is interacted by at least one merchant 118. The environment 100 further comprises a server 108 which is equipped with a referral reward platform and a database 110. The referrer device 102, the consumer device 104, the merchant device 106, the server 108 and the database 110 communicate through a communication network 112. The referrer 114, the consumer 116 and the merchant 118 communicate with the referral reward platform through the referrer device 102, the consumer device 104 and the merchant device 106. The referrer device 102 communicates with the consumer device 104 for accomplishing referral programs of the merchant 118.

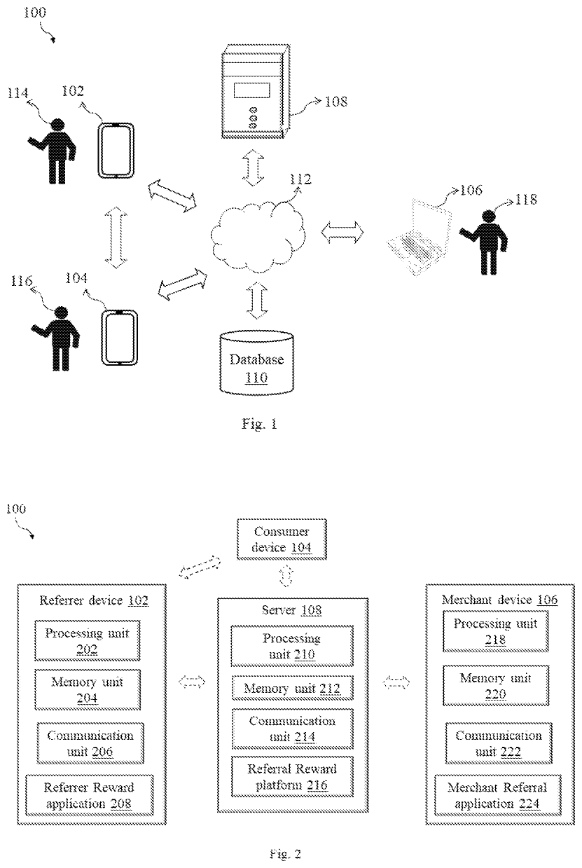

FIG. 2 illustrates components of the system 100 for the referral rewards.

In an embodiment, the referrer device 102 comprises a processing unit 202, a memory unit 204, a communication unit 206 and a referrer reward application 208.

In an embodiment, the processing unit 202 may comprise one or more of microprocessors, circuits, and other hardware configured for processing. The processing unit 202 is configured to execute instructions stored in the memory unit 204 as well as communicate with referrer device 102 through an input/output module via the communication unit 206.

In an embodiment, the memory unit 204 comprises one or more volatile and non-volatile memory components which are capable of storing data and instructions to be executed.

In an embodiment, the communication unit 206 of the referrer device may include wired and wireless communication, including but not limited to, GPS, GSM, LAN, Wi-fi compatibility, Bluetooth Low Energy as well as NFC. The wireless communication may further comprise one or more of Bluetooth, ZigBee, a short-range wireless communication such as UWB, a medium-range wireless communication such as WiFi or a long-range wireless communication such as 3G/4G or WiMAX, according to the usage environment.

In an embodiment, the server 108 may be a hardware-based server or a cloud server. Further, the server 108 comprises a processing unit 210, a memory unit 212, a communication unit 214 and a referral reward platform 216.

In an embodiment, the merchant device 106 comprises a processing unit 218, a memory unit 220, a communication unit 222 and a merchant referral application 224.

In an embodiment, the processing unit 210, the memory unit 212, and the communication unit 214 of the server 108 and the processing unit 218, the memory unit 220, and the communication unit 222 of the merchant device 106 are similar in function and build, when compared to the processing unit 202, memory unit 204, and communication unit 206 of the referrer device 102.

The referrer reward application 208 of the referrer device 102 and merchant referral application 224 of the merchant device 106 contribute similar functionalities to accomplish the referral rewards by communicating with the referral reward platform 216 of the server 108.

The referral reward platform 216 links the referrer device 102 of the referrer 114 who is passionate to participate in referring products and services shared by the merchant 118, to the consumer device 104. Each referrer device 102 may refer multiple products and services shared by a plurality of merchant devices 106. The merchant devices 106 communicate the referral programs to the referral reward platform 216 through the merchant referral application 224, for further use by the referrer device 102. The referral programs comprise information of products and services that are to be referred, to accomplish a marketing campaign. The referrer device 102 receives rewards when the consumer 116 purchases the referred products and services at the point of sale through their consumer devices 104.

The consumer device 104 may also be benefitted with rewards for the purchase through the referral program, from at least one of: the referrer device 102, the merchant device 106 and a referrer company. The referrer company implements the referral reward platform 216 and enables the referrer device 102 and the merchant device 106 to register and participate in marketing campaigns.

Each participating merchant device 106 decides a percentage of rewards for the referrer device 102 for each referral program, and the merchant device 106 is only charged after the transaction by the consumer device 104 is accomplished. The referrer device 102 may obtain rewards in monetary value. The merchants 118 owning the merchant devices 106 may comprise one or more of vendors, service providers, and suppliers of multiple business entities. The consumers 116 of the consumer devices 104 may comprise friends, relatives, or colleagues etc.

In an embodiment, the referrer device 102, the consumer device 104 and the merchant device 106 may comprise any electronic computing device such as but not limited to, a smart phone, a mobile device/phone, a Personal Digital Assistant (PDA), a computer, a workstation, a notebook, a mainframe computer, a laptop, a tablet, an internet appliance and any other computing device that is capable of accessing the referral reward platform 216.

In an embodiment, the referrer device 102, the consumer device 104 and the merchant device 106 may comprise a smartphone, a mobile phone, a laptop or a computer. The referral reward platform 216 may be implemented in the form of a website or a web application. Further, the referrer reward application 208 and the merchant referral application 224 may be implemented in the form of mobile applications.

In an embodiment, the server 108 is a device capable of processing data related to the referral reward platform 216, a plurality of referrer devices 102 and the plurality of merchant devices 106. The server 108 processes the referral programs and financial transactions at the point of sale performed by the plurality of consumer devices 104.

In an embodiment, the server 108 is configured to process data related to the referral reward platform 216 implementing artificial intelligence-based algorithms.

In an embodiment, the database 110 is configured to store the processed data of the referral reward platform 216 which comprises information related to the referrer devices 102, the merchant devices 106, the consumer devices 104, the referral programs and the financial transactions generated between the referrer devices 102, the consumer devices 104 and the merchant devices 106 at the point of sale.

The database 110 may also store or enable various operations performed by the referrer device 102, the consumer device 104, the merchant device 106 and the server 108. The database 110 may be operated either as a local database or a remote database. The database 110 may comprise one or more volatile and non-volatile memory components which are capable of storing data and instructions to be executed, as well as various memories, comprising but not limited to a Random-Access Memory (RAM) and a Read Only Memory (ROM).

In an embodiment, the database 110 may be used as a stand-alone device, or may be integrated fully or partially into at least one of the referrer device 102, the consumer device 104 and the merchant device 106 and the server 108. The database 110 may also be distributed with one portion accessed by the referrer device 102, the consumer device 104 and the merchant device 106; and the other portion provided on the server 108. The database 110 may also be a cloud database that can be accessed through the communication network 112.

In an embodiment, the communication network 112 through which the server 108 and the database 110 communicate may be in the form of either a wired network or a wireless network or a combination thereof. The wired and wireless communication may comprise but not limited to, GPS, GSM, LAN, Wi-fi compatibility, Bluetooth low energy as well as NFC. The wireless communication may further comprise one or more of Bluetooth (registered trademark), ZigBee (registered trademark), a short-range wireless communication such as UWB, a medium-range wireless communication such as WiFi (registered trademark) or a long-range wireless communication such as 3G/4G or WiMAX (registered trademark), according to the usage environment.

The communication network 112 is capable of transmitting or receiving data to/from host computers, personal devices, telephones or any other electronic devices. The communication network 112 may comprise any software, hardware, or computer applications.

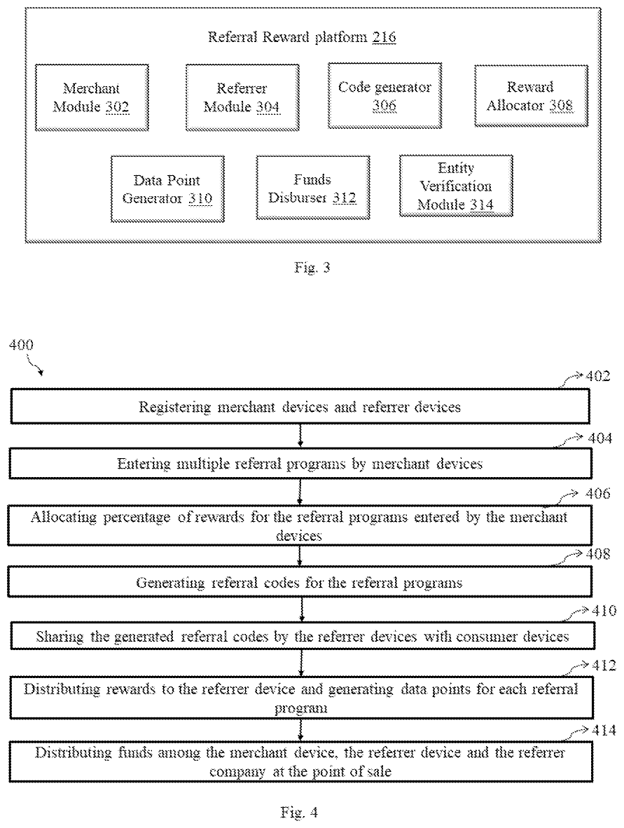

FIG. 3 illustrates a block diagram of components of the referral reward platform 216 is implemented in the server 108.

In an embodiment, the referral reward platform 216 comprises a merchant module 302, a referrer module 304, a code generator 306, a reward allocator 308, a data point generator 310, a funds disburser 312 and an entity verification module 314.

In an embodiment, the merchant module 302 enables the plurality of merchant devices 106 to register with the referral reward platform 216. The registration process may consist of two types of accounts, such as a new (start-up) business registration and an existing business registration. The merchant devices 106 may have the ability to register their business profile across all electronic devices such as desktop, laptop, tablet and mobile devices. The merchant devices 106 may have access to a web-based registration form and APP based registration form.

The merchant module 302 is configured to generate and issue at least one merchant identifier to the at least one merchant device 106 during registration. The merchant identifier may comprise a unique identification number (UIN). After registration, the merchant device 106 enters at least one referral program with relevant percentage of rewards into the merchant module 302. The referral program may comprise referral information of at least one product, service, brand and event of at least one business entity of the merchant 118.

In an embodiment, the merchant module 302 is configured to enable the merchant device 106 to:

track the number of referral programs their business entities have generated in real-time,
amend the percentage of rewards offered to the referrer device 102,
implement multiple promotional offers, and
invite the referrer device 102 to their business entities using artificial intelligence-based algorithms.

The referral reward platform 216 enables new businesses to invite the referrers 114 of the referrer devices 102 to participate in grand openings, experience new products and services, and share their experience with their friends, family and followers.

In an embodiment, the referrer module 304 enables the plurality of referrer devices 102 to register into the referral reward platform 216. The registration process may comprise two types of accounts such as a referrer account which automatically provides the referrer 102 with a consumer rewards program and a consumer account which consists of the rewards program only. The consumer accounts may have the ability to upgrade their accounts from a rewards only account to a referrer/consumer rewards account at any given time.

The referrer module 304 is configured to generate at least one referrer identifier for the at least one referrer device 102 during registration. The referrer identifier may comprise a personal identification number (PIN). The referrer device 102 may have the ability to update their personal information through the referrer module 304. All registered referrer devices 102 will be able to refer any product or service available by registered merchant devices 106. Further, the referrer device 102 may have the ability to track pending and settled transactions.

In an embodiment, the code generator 306 is configured to generate at least one referral code for the referral program entered by the merchant device 106. The referral code may comprise at least one of a link, a bar code, a QR code, an identifier and a coupon to refer the product, service, brand and event. The referral code may further comprise review or ingredients or results of a particular product or service.

The referrer module 304 enables the referrer device 102 to select the referral program and share the referral code corresponding to the selected referral program to at least one consumer device 104. The referrer device 102 shares the referral code via at least one of their social media accounts, messenger applications, e-mail and personal e-commerce sites.

In an embodiment, the reward allocator 308 is configured to allocate percentages of rewards to the referrer device 102. A relevant percentage of rewards is allocated when the consumer device 104 utilizes the referral code corresponding to the selected referral program at the point of sale. The purchase transaction may be accomplished by the consumer device 104 either in-store or through e-commerce platforms, applications or websites.

In an embodiment, a data point generator 310 is configured to generate and allocate at least one data point to the referrer device 102 for accomplishing the referral program. The data point generator 310 facilitates connecting the merchant device 106 with the best/most effective referrer 114 based on the allocated data points of the referrer device 102. Other benefits may be provided to the referrer device 102 or the merchant device 106, based on a total number of collected data points.

In an embodiment, a funds disburser 312 is configured to distribute funds generated at the point of sale for the referral program, simultaneously, among the merchant device 106, the referrer device 102 and the referrer company by using artificial intelligence-based algorithms.

In an embodiment, the code generator 306 is configured to pair the merchant identifier and the referrer identifier while generating the referral code. The paired identifiers aid in tracking and collecting the allocated data points on referred products, services, brands, events, and in tracking the financial transactions during a referrer's marketing or promotional campaign, and at the point of sale.

In an embodiment, the artificial intelligence is implemented to control and monitor security and registration processes of the merchant devices 106, the referrer devices 102 and the consumer devices 104, as well as to generate and allocate data points.

The artificial intelligence algorithms are deployed to serve and monitor financial transactions, and oversee all processes. The artificial intelligence algorithms play a crucial part in providing assistance with all financial, social media and e-commerce integrations. The artificial intelligence algorithms also serve as a paramount key feature in connecting the merchant devices 106 with the best/most effective referrers 114, based on the respective stored and collated data points.

In an embodiment, an entity verification module 314 is configured to verify identities of the referrer devices 102, the merchant devices 106 and their business entities during registration, by communicating with one or more government facilitated systems. AU existing and brand-new businesses undergo a strict verification process, and by subjected to ongoing monitoring by the artificial intelligence algorithms in order to assist the referrer company and all governmental agencies. Advantageously, the entity verification module 314 enables the prevention of money laundering or any other fraudulent or illegal activities.

Further, the database 110 is configured to store the processed data of the referral reward platform 216, where the processed data comprises information related to the merchant device 106, the referrer device 102, the consumer device 104, the referral program, the referral code and financial transactions generated between the referrer device 102, the consumer device 104 and the merchant device 106 at the point of sale.

In an embodiment, each referral code is tracked by the artificial intelligence to attain data points on how many people have viewed the referral code, how many have attempted to use the referral code across e-commerce platforms and how many have successfully used the referral code.

In an embodiment, the referral codes for in store purchases may be available in the form of a pass code, bar code, or QR code, which can be scanned by the merchant's scanner at the point of sale and checkout. In case of merchants 118 who do not have scanners, the merchants 118 will be able to enter the referral code manually into their point of sale systems. Further, each referral code may be set with an expiration date by the referrer device 102. Each product or service may be generated with multiple referral codes.

FIG. 4 illustrates a referral reward method 400 to carry out the referral reward program. The method 400 begins with registration of the merchant devices and the referrer devices into the referral reward platform, as depicted at step 402, by using the merchant module and the referrer module. Subsequently, the method 400 discloses entering multiple referral programs into the referral reward platform by merchant devices, as depicted at step 404, by using the merchant module.

Thereafter, the method 400 discloses allocation of percentage of rewards by the merchant devices for the entered referral programs, as depicted at step 406, by using the merchant module. Subsequently, generation of referral codes corresponding to the referral programs is carried out, as depicted at step 408, by using the code generator. Further, the generated referral codes are shared by the referrer devices with consumer devices, as depicted at step 410, via social media accounts, messenger applications, email and personal e-commerce sites.

Subsequently, the referral reward platform distributes rewards to the referrer devices upon any transactions completed by the consumer device at a point of sale using the shared referral code, by using a reward allocator, and generates data points to the referrer device for each referral program, by using the data point generator, as depicted at step 412. Thereafter, overall funds generated for the products and services at the point of sale are distributed among the merchant devices, the referrer devices and the referrer company, as depicted at step 414, by using the funds disburser.

FIG. 5 illustrates a method 500 of the merchant devices using the referral reward platform. The method 500 begins with registration of the merchant module into the referral reward platform, as depicted at step 502. Subsequently, the method 500 discloses entering referral programs and corresponding percentage of rewards by using the merchant devices, as depicted at step 504, for their products and services.

Thereafter, the method 500 discloses entering promotional offers, as depicted at step 506, by using the merchant devices. Further, the referral programs are tracked in real-time as depicted at step 508. Subsequently, the referrers are invited to their business entities, as depicted at step 510.

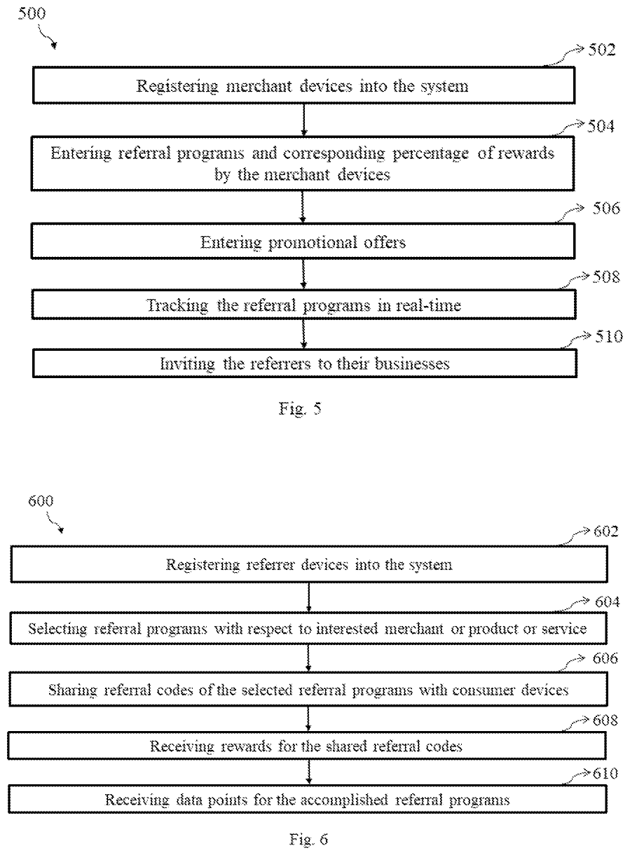

FIG. 6 illustrates a method 600 of using the referral reward platform by the referrer devices. The method 600 begins with registration of the referrer devices into the referral reward platform, as depicted at step 602. Subsequently, the method 600 discloses selection of referral programs by each referrer device with respect to interested merchant or product or service, as depicted at step 604.

Thereafter, the method 600 discloses sharing referral codes of selected referral programs with consumers, as depicted at step 606. Further, rewards corresponding to the shared referral codes are received by the referrer devices, in case the consumer devices complete transactions using the shared referral codes, as depicted at step 608. Next, the referrer devices are received with data points for the accomplished referral programs, as depicted at step 610.

The advantages of the current invention comprise the proposed referral reward platform that provides a pay-per-sale system to capitalize on the way people are rewarded for influencing the referral of products and services to the global community. The referrer company works with merchants to reward the referees and the consumers for successful referrals in such a way to both stimulate businesses, and provide financial reward for members of the broader community.

Once the merchant device is registered into the referral reward platform, the referrer devices have the ability to promote any products or services they are personally satisfied with after the purchase, or via a merchant's special invitation in order to influence others, thus creating an honest referral with 100% return on dividend investment guarantee, at no upfront costs to the merchant.

The referrer may be able to take a picture of a product, share their experience in person, via social media, messenger apps, email or via e-commerce platforms.

The artificial intelligence-based algorithms and other algorithms manage all the processes such as referrer device and merchant device registrations, data hosting, data points, active and historical referral data, referral laws and regulations, along with cryptograms associated with such technical processes, financial transactions, and rewards programs. Further, the referral reward platform with artificial intelligence-based algorithms and other algorithms enables for streamlined integration to all current point of sale systems, e-commerce platforms, merchant facilities, buy now pay later (BNPL) platforms, social media accounts, digital messaging systems and respective bookkeeping software.

The referral reward platform enables tracking successful sales, clicks, abandoned carts and the overall success of every campaign in order to receive correctly acquired commissions, thus eliminating prior procedures of lengthy and inaccurate invoicing methods. The referral reward platform may also be utilized by suppliers to track and settle outstanding accounts at the point of sale by the merchants.

The referral reward platform facilitates integration of e-commerce and in-store platform through referral programs. This process enables for businesses to have direct engagement with the general public, and vice versa, with the added benefit of facilitating an actual return on advertising investment for the merchant, in the form of a converted sales transaction. The referral reward platform enables for an immediate settlement of accounts and commissions through algorithms and artificial intelligence, at the point of sale.

Applications of the current invention may comprise retail stores, e-commerce sites, stock market, trade, real estate, and other markets which deal with products or services marketing or trading.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described here.

We claim:

1. A system (100) for referral rewards, comprising:
at least one referrer device (102) configured with a referrer reward application (208);
at least one merchant device (106) configured with a merchant referral application (224); and
a server (108) configured with a referral reward platform (216) for communicating and processing data of the referrer reward application (208) and the merchant referral application (224) by implementing artificial intelligence-based algorithms, wherein the referral reward platform (216) comprises:
a merchant module (302) configured to receive at least one referral program with relevant percentage of rewards from the at least one merchant device (106);
a code generator (306) configured to generate at least one referral code corresponding to the received referral program;
a referrer module (304) configured to identify at least one referral program selected by the referrer device (102) and share the at least one referral code corresponding to the selected at least one referral program to at least one consumer device (104); and
a reward allocator (308) configured to allocate a relevant percentage of rewards to the referrer device (102) corresponding to the selected at least one referral program, in case the consumer device (104) utilizes the at least one referral code at a point of sale.

2. The system (100) for referral rewards as claimed in claim 1, wherein the at least one referral program comprises referral information of at least one product, service, brand and event of at least one business entity, and
wherein the at least one referral code comprises at least one of a link, a bar code, a QR code, an identifier and a coupon to refer the at least one product, service, brand and event.

3. The system (100) for referral rewards as claimed in claim 1, wherein the referral reward platform (216) comprises a funds disburser (312) configured to distribute funds generated at the point of sale for the at least one referral program, among at least one of the merchant device (106), the referrer device (102) and at least one referrer company.

4. The system (100) for referral rewards as claimed in claim 1, wherein the at least one referrer device (102) shares the at least one referral code via at least one of their social media accounts, messenger applications, email and personal e-commerce sites.

5. The system (100) for referral rewards as claimed in claim 1, wherein the merchant module (302) is configured to enable the at least one merchant device (106) to track the number of referral programs generated in real-time by business entities, to amend the percentage of rewards offered to the at least one referrer device (102), implement multiple promotional offers, and invite the at least one referrer device (102) to their business entities.

6. The system (100) for referral rewards as claimed in claim 1, wherein at least one referrer company implements the referral reward platform (216) and enables the at least one referrer device (102) and the at least one merchant device (106) to register and participate in marketing campaigns.

7. The system (100) for referral rewards as claimed in claim 1, wherein a data point generator (310) is configured to generate and allocate at least one data point to the at least one referrer device (102) for accomplishing the at least one referral program, and wherein the data point generator (310) connects the at least one merchant device (106) with a referrer, based on the allocated data points.

8. The system (100) for referral rewards as claimed in claim 1, wherein:
the merchant module (302) is configured to generate at least one merchant identifier for the at least one merchant device (106);
the referrer module (304) is configured to generate at least one referrer identifier for the at least one referrer device (102); and
the code generator (306) is configured to pair the at least one merchant identifier and the at least one referrer identifier while generating the at least one referral code, to enable tracking and collecting the allocated data points on referred products, services, brands, events, and tracking the financial transactions at the point of sale.

9. The system (100) for referral rewards as claimed in claim 1, wherein a database (110) is configured to store the processed data of the referral reward platform (216), wherein the processed data comprises information related to the at least one merchant device (106), the at least one referrer device (102), the at least one consumer device (104), the at least one referral program, the at least one referral code and financial transactions generated between the at least one merchant device (106), the at least one referrer device (102) and the at least one consumer device (104) at the point of sale.

10. The system (100) for referral rewards as claimed in claim 1, wherein an entity verification module (314) is configured to verify identities of the at least one referrer device (102), the at least one merchant device (106) and their business entities at the point of registration by communicating with government facilitated systems.

11. A method for rewarding referrals, comprising:
receiving at least one referral program from at least one merchant device (106) through a merchant referral application (224);
generating at least one referral code corresponding to the received at least one referral program;
Identifying at least one referral program selected by the at least one referrer device (102), through a referrer reward application (208);
sharing the at least one referral code corresponding to the selected at least one referral program to at least one consumer device (104);
processing data related to the merchant referral application (224) and the referrer reward application (208) by a referral reward platform (216) using artificial intelligence-based algorithms;
allocating a relevant percentage of rewards to the referrer device (102) corresponding to the selected at least one referral program, in case the at least one referral code is utilized by the at least one consumer device (104) at a point of sale.

12. The method for referral rewards as claimed in claim 11, comprising:
entering the at least one referral program comprising a referral information of at least one product, service, brand and event of at least one business entity;
referring the at least one product, service, brand and event by using the at least one referral code comprising at least one of a link, a bar code, a QR code, an identifier and a coupon; and
sharing the at least one referral code via at least one of their social media accounts, messenger applications, email and personal e-commerce sites.

13. The method for referral rewards as claimed in claim 11, comprising distributing funds generated at the transaction for the at least one referral program, among at least one of the merchant device (106), the referrer device (102) and at least one referrer company, by using a funds disburser (312).

14. The method for referral rewards as claimed in claim 11, comprising enabling the at least one merchant device (106) for:
tracking the number of referral programs their business entities have generated in real-time;
amending the percentage of rewards offered to the at least one referrer device (102);
implementing multiple promotional offers; and
inviting the at least one referrer device (102) to their business entities, by using the merchant module (302).

15. The method for referral rewards as claimed in claim 11, comprising:
implementing the referral reward platform (216) by the at least one referrer company; and
enabling the at least one referrer device (102) and the at least one merchant device (106) for registering and participating in marketing campaigns.

16. The method for referral rewards as claimed in claim 11, comprising:
generating and allocating at least one data point to the at least one referrer device (102) for accomplishing the at least one referral program, by using a data point generator (310); and
connecting the at least one merchant device (106) with a referrer based on the allocated data points.

17. The method for referral rewards as claimed in claim 11, comprising:
generating at least one merchant identifier for the at least one merchant device (106), by using a merchant module (302);
generating at least one referrer identifier for the at least one referrer device (102, by using a referrer module (304);
pairing the at least one merchant identifier and the at least one referrer identifier while generating the at least one referral code, by using the code generator (306); and
tracking and collecting the allocated data points on referred products, services, brands, events, and tracking the financial transactions at the point of sale by using the paired identifiers.

18. The method for referral rewards as claimed in claim 11, comprising storing the processed data of the referral reward platform (216), by using a database (110), wherein the processed data comprises information related to the at least one merchant device (106), the at least one referrer device (102), the at least one consumer device (104), the at least one referral program, the at least one referral code and financial transactions generated between the at least one merchant device (106), the at least one referrer device (102) and the at least one consumer device (104) at the point of sale.

19. The method for referral rewards as claimed in claim 11, comprising verifying identities of the at least one referrer device (102), the at least one merchant device (106) and their business entities at the point of registration by communicating with government facilitated systems, by using an entity verification module (314).
